(19) United States
(12) Patent Application Publication
(10) Pub. No.: US 2025/0220656 A1
(43) Pub. Date: Jul. 3, 2025

(54) SIGNAL TRANSMISSION METHOD AND APPARATUS, COMMUNICATION DEVICE, AND STORAGE MEDIUM

(71) Applicant: VIVO MOBILE COMMUNICATION CO., LTD., Dongguan (CN)

(72) Inventors: Rongling JIAN, Dongguan (CN); Kai WU, Dongguan (CN); Junjie TAN, Dongguan (CN)

(21) Appl. No.: 19/084,768

(22) Filed: Mar. 20, 2025

Related U.S. Application Data
(63) Continuation of application No. PCT/CN2023/119473, filed on Sep. 18, 2023.

(30) Foreign Application Priority Data
Sep. 22, 2022 (CN) 202211158921.1

(51) Int. Cl. H04W 72/0453; H04L 5/14; H04W 72/51

(52) U.S. Cl. CPC H04W 72/0453; H04L 5/14; H04W 72/51

(57) ABSTRACT

This application discloses a signal transmission method and apparatus, a communication device, and a storage medium, and relates to the field of communications technologies. A signal transmission method in embodiments of this application includes: A first communication device receives a second signal sent by a second communication device, where a first frequency domain resource used to transmit a signal sent by the first communication device is different from a second frequency domain resource used to transmit the second signal. Another signal transmission method in the embodiments of this application includes: A second communication device receives a first signal sent by a first communication device. The second communication device sends a second signal based on the first signal, where a first frequency domain resource used to transmit the first signal is different from a second frequency domain resource used to transmit the second signal.

### CROSS-REFERENCE TO RELATED APPLICATIONS

This application is a continuation of International Patent Application No. PCT/CN2023/119473, filed on Sep. 18, 2023, which claims priority to Chinese Patent Application No. 202211158921.1, filed with the China National Intellectual Property Administration on Sep. 22, 2022 and entitled “SIGNAL TRANSMISSION METHOD AND APPARATUS, COMMUNICATION DEVICE, AND STORAGE MEDIUM”, both of which are incorporated herein by reference in their entireties.

### TECHNICAL FIELD

This application relates to the field of communications technologies, and specifically, to a signal transmission method and apparatus, a communication device, and a storage medium.

### BACKGROUND

Backscatter communication (Backscatter Communication, BSC) means that a backscatter communication device performs signal modulation by using a radio frequency signal in another device or an environment to transmit information of the backscatter communication device. In a backscatter communication system, the backscatter communication device, such as a tag (tag) device, may receive control signaling or a carrier signal of a reader (reader), modulate to-be-transmitted data to the carrier signal according to an indication, and send a backscatter signal to the reader.

### SUMMARY

Embodiments of this application provide a signal transmission method and apparatus, a communication device, and a storage medium. According to a first aspect, a signal transmission method is provided, and includes:

A first communication device receives a second signal sent by a second communication device, where
a first frequency domain resource used to transmit a signal sent by the first communication device is different from a second frequency domain resource used to transmit the second signal.

According to a second aspect, a signal transmission apparatus is provided, and includes:
a first receiving module, configured to receive a second signal sent by a second communication device, where
a first frequency domain resource used to transmit a signal sent by a first communication device is different from a second frequency domain resource used to transmit the second signal.

According to a third aspect, a signal transmission method is provided, and includes:

A second communication device receives a first signal sent by a first communication device.

The second communication device sends a second signal based on the first signal, where
a first frequency domain resource used to transmit the first signal is different from a second frequency domain resource used to transmit the second signal.

According to a fourth aspect, a signal transmission apparatus is provided, and includes:
a second receiving module, configured to receive a first signal sent by a first communication device; and
a second sending module, configured to send a second signal based on the first signal, where
a first frequency domain resource used to transmit the first signal is different from a second frequency domain resource used to transmit the second signal.

According to a fifth aspect, a communication device is provided, and includes a processor and a memory. The memory stores a program or an instruction that is executable on the processor. The program or the instruction is executed by the processor to implement the steps of the method in the first aspect or the steps of the method in the third aspect.

According to a sixth aspect, a communication system is provided, and includes a first communication device and a second communication device. The first communication device may be configured to perform the steps of the method in the first aspect, and the second communication device may be configured to perform the steps of the method in the third aspect.

According to a seventh aspect, a readable storage medium is provided. The readable storage medium stores a program or an instruction. The program or the instruction is executed by a processor to implement the steps of the method in the first aspect or the steps of the method in the third aspect.

According to an eighth aspect, a computer program/program product is provided. The computer program/program product is stored in a storage medium, and the computer program/program product is executed by at least one processor to implement the steps of the method in the first aspect or the steps of the method in the third aspect.

### BRIEF DESCRIPTION OF DRAWINGS

FIG. 1 is a block diagram of a wireless communication system to which embodiments of this application may be applied;

FIG. 2 is a schematic diagram of a full-duplex backscatter communication process in a related technology;

FIG. 3 is a schematic diagram of a full-duplex backscatter communication principle in a related technology;

FIG. 4 is an implementation flowchart of a signal transmission method according to an embodiment of this application;

FIG. 5 is a schematic diagram of an application scenario according to an embodiment of this application;

FIG. 6 is a schematic diagram of another application scenario according to an embodiment of this application;

FIG. 7 is a schematic diagram of another application scenario according to an embodiment of this application;

FIG. 8 is a schematic diagram of another application scenario according to an embodiment of this application;

FIG. 9 is a schematic diagram of a resource configuration according to an embodiment of this application;

FIG. 10 is a schematic diagram of a frequency shift setting according to an embodiment of this application;

FIG. 11 is a schematic diagram of a signal transmission process according to an embodiment of this application;

FIG. 12 is a schematic diagram of another frequency shift setting according to an embodiment of this application;

FIG. 13 is a schematic diagram of a structure of a signal transmission apparatus corresponding to FIG. 4 according to an embodiment of this application;

FIG. 14 is an implementation flowchart of another signal transmission method according to an embodiment of this application;

FIG. 15 is a schematic diagram of a structure of a signal transmission apparatus corresponding to FIG. 14 according to an embodiment of this application;

FIG. 16 is a schematic diagram of a structure of a communication device according to an embodiment of this application;

FIG. 17 is a schematic diagram of a structure of a terminal device according to an embodiment of this application; and

FIG. 18 is a schematic diagram of a structure of a network side device according to an embodiment of this application.

### DESCRIPTION OF EMBODIMENTS

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

The terms “first”, “second”, and the like in this specification and claims of this application are used to distinguish between similar objects instead of describing a specific order or sequence. It should be understood that, the terms used in such a way are interchangeable in proper circumstances, so that the embodiments of this application can be implemented in an order other than the order illustrated or described herein. Objects classified by “first” and “second” are usually of a same type, and a quantity of objects is not limited. For example, there may be one or more first objects. In addition, in the description and the claims, “and/or” represents at least one of connected objects, and a character “/” generally represents an “or” relationship between associated objects.

It should be noted that technologies described in the embodiments of this application are not limited to a Long Term Evolution (Long Term Evolution, LTE)/LTE-Advanced (LTE-Advanced, LTE-A) system, and may further be applied to other wireless communication systems such as Code Division Multiple Access (Code Division Multiple Access, CDMA), Time Division Multiple Access (Time Division Multiple Access, TDMA), Frequency Division Multiple Access (Frequency Division Multiple Access, FDMA), Orthogonal Frequency Division Multiple Access (Orthogonal Frequency Division Multiple Access, OFDMA), single-carrier frequency division multiple access (Single-carrier Frequency Division Multiple Access, SC-FDMA), and other systems. The terms “system” and “network” in the embodiments of this application may be used interchangeably. The technologies described can be applied to both the systems and the radio technologies mentioned above as well as to other systems and radio technologies. A new radio (New Radio, NR) system is described in the following description for illustrative purposes, and the NR terminology is used in most of the following description, although these technologies can also be applied to applications other than the NR system application, such as the 6th generation (6th Generation, 6G) communication system.

Because frequencies of signals sent and received by the reader are basically consistent, the reader is interfered by a transmitted signal when receiving the backscatter signal, which causes the reader in the backscatter communication system to fail to send and receive signals at the same time, increasing difficulty in full-duplex backscatter communication and reducing signal transmission efficiency.

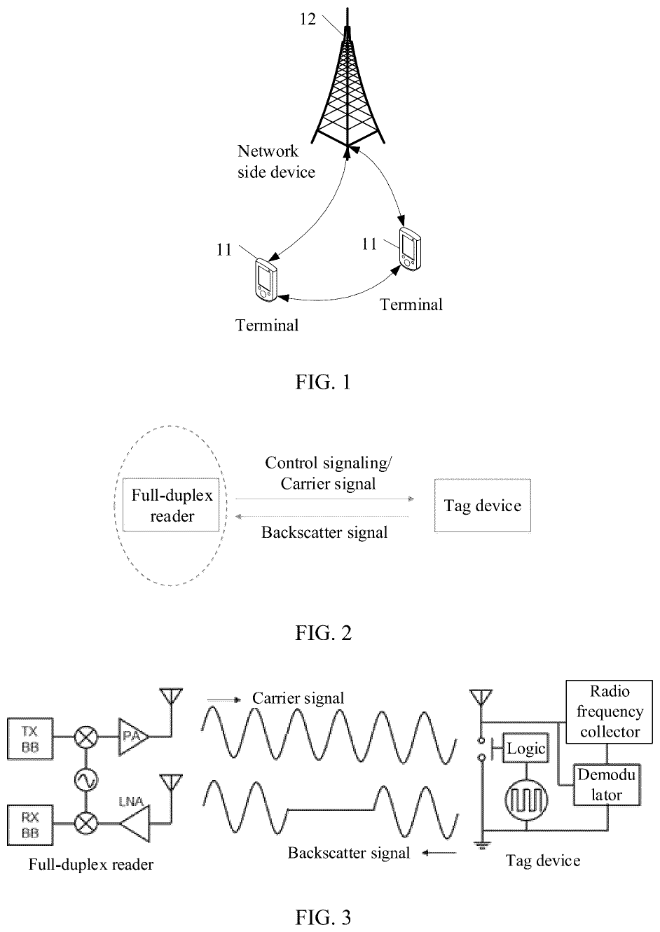

FIG. 1 is a block diagram of a wireless communication system to which embodiments of this application may be applied. The wireless communication system includes a terminal 11 and a network side device 12.

The terminal 11 may be a terminal side device such as a mobile phone, a tablet personal computer (Tablet Personal Computer), a laptop computer (Laptop Computer) or a notebook computer, a personal digital assistant (Personal Digital Assistant, PDA), a palmtop computer, a netbook, an ultra-mobile personal computer (ultra-mobile personal computer, UMPC), a mobile internet device (Mobile Internet Device, MID), an augmented reality (augmented reality, AR)/virtual reality (virtual reality, VR) device, a robot, a wearable device (Wearable Device), vehicle user equipment (VUE), pedestrian user equipment (PUE), a smart home (a home device with a wireless communication function, such as a refrigerator, a television, a washing machine, or a furniture), a game console, a personal computer (personal computer, PC), a teller machine, or a self-service machine. The wearable device includes a smart watch, a smart band, a smart headset, smart glasses, smart jewelry (a smart bangle, a smart bracelet, a smart ring, a smart necklace, a smart anklet, a smart chain, and the like), a smart wrist strap, a smart dress, and the like. It should be noted that a specific type of the terminal 11 is not limited in the embodiments of this application.

The network side device 12 may include an access network device or a core network device. The access network device may also be referred to as a radio access network device, a radio access network (Radio Access Network, RAN), a radio access network function, or a radio access network unit. The access network device may include a base station, a WLAN access point, a Wi-Fi node, or the like. The base station may be referred to as a NodeB, an evolved NodeB (eNB), an access point, a base transceiver station (Base Transceiver Station, BTS), a radio base station, a radio transceiver, a basic service set (Basic Service Set, BSS), an extended service set (Extended Service Set, ESS), a home NodeB, a home evolved NodeB, a transmitting receiving point (Transmitting Receiving Point, TRP), or another appropriate term in the field. Provided that a same technical effect is achieved, the base station is not limited to a specified technical term. It should be noted that, in the embodiments of this application, only a base station in an NR system is used as an example for description, and a specific type of the base station is not limited.

For ease of understanding, application scenarios, and related technologies and concepts in the embodiments of this application are first described.

The technical solutions provided in the embodiments of this application can be applied to a full-duplex backscatter communication scenario, another full-duplex communication scenario, and the like, and specifically, can be applied to items inventory, logistics inventory, fire warning, and other scenarios.

For example, a first communication device is a reader, and a second communication device is a passive tag device, semi-passive tag device, or active tag device. The first communication device may send a first signal, receive a second signal sent by the second communication device based on the first signal, where a first frequency domain resource used to transmit the first signal is different from a second frequency domain resource used to transmit the second signal.

For another example, a second communication device is an active tag device, such as a sensor or another device, may actively send a second signal, such as may actively send a second signal carrying temperature, humidity, and other measurement information, and a first communication device receives the second signal sent by the second communication device, where a first frequency domain resource used to transmit a signal sent by the first communication device is different from a second frequency domain resource used to transmit the second signal.

In this way, this can avoid interference to the first communication device caused by the signal sent by the first communication device when receiving the second signal sent by the second communication device. Therefore, the first communication device can send and receive signals at the same time, to reduce difficulty in full-duplex communication and improve signal transmission efficiency.

Provided that there is a communication device to send and receive signals at the same time, the technical solutions provided in the embodiments of this application can be used. For ease of description, the embodiments of this application are mainly described by using an example in which the technical solutions are applied to a full-duplex backscatter communication system in the embodiments of this application.

Backscatter communication means that a backscatter communication device performs signal modulation by using a radio frequency signal in another device or an environment to transmit information of the backscatter communication device.

In a conventional radio frequency identification (radio frequency identification, RFID) technology, the backscatter communication device is usually a tag (Tag) device belonging to a passive Internet of Things (Internet of Things, IoT) device (Passive-IoT).

The backscatter communication device may alternatively be a semi-passive (semi-passive) tag device. Such a tag device has a specific amplification capability for downlink receiving or uplink reflection.

The backscatter communication device may alternatively be a tag device having an active sending capability, that is, an active tag device (active tag). Such a tag device may send a signal to a reader without relying on an incident signal.

FIG. 2 is a schematic diagram of a full-duplex backscatter communication process. There are two links in this process, one is a link from a reader to a tag device, and the reader may send a control command (command)/a carrier signal to the tag device. The carrier signal may be a continuous wave (continuous wave). The other is a link from the tag device to the reader, and the tag device may return a backscatter signal to the reader.

In a simple implementation, the tag device reflects an incident carrier signal when needing to send “1”, and does not reflect an incident carrier signal when needing to send “0”.

FIG. 3 is a schematic diagram of a full-duplex backscatter communication principle in a related technology. A transmitting end of a reader sends a carrier signal through a power amplifier (PA), and a tag device performs signal modulation through a radio frequency collector, a demodulator, a logic circuit, a clock circuit, and the like, to output a backscatter signal. A receiving end of the reader receives a reflection signal through a low noise amplifier (LNA) for corresponding processing. The tag device may control a reflection coefficient Γ of a circuit by adjusting internal impedance of the tag device, to change an amplitude, a frequency, a phase, and the like of an incident carrier signal, and implement signal modulation. A reflection coefficient of a signal may be represented as:

$$Γ = \frac{{Z}_{1} - {Z}_{0}}{{Z}_{1} + {Z}_{0}} = \vert Γ \vert {e}^{j {θ}_{T}} .$$

Z₀ is antenna characteristic impedance, and Z₁ is load impedance. It is assumed that the incident carrier signal is Sᵢₙt). In this case, an output reflection signal is Sₒᵤₜ(t)=^{S}ᵢₙ(t)|Γ|e^{jθ}^{_{T}}. Therefore, corresponding amplitude modulation, frequency modulation, or phase modulation can be implemented through proper control on the reflection coefficient.

The possible application scenarios, and related technologies and concepts in the embodiments of this application are described above. The following describes in detail a signal transmission method provided in the embodiments of this application by using some embodiments and application scenarios thereof with reference to the accompanying drawings.

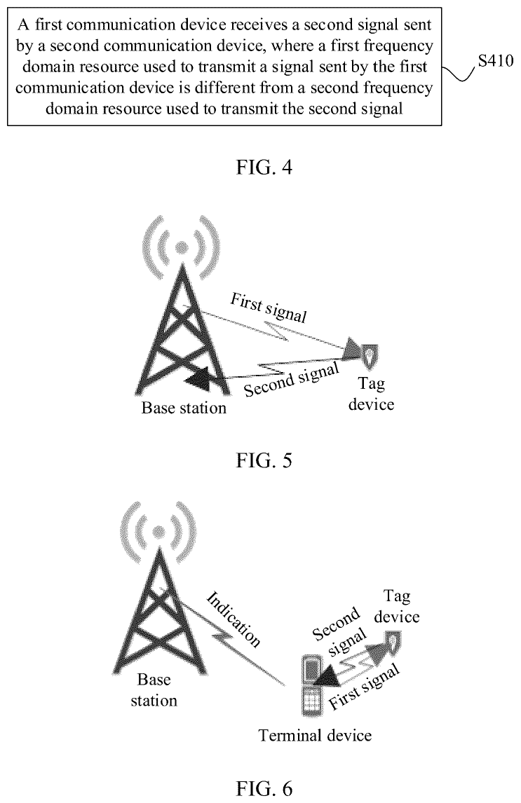

FIG. 4 is an implementation flowchart of a signal transmission method according to an embodiment of this application. The method may include the following steps:

S410: A first communication device receives a second signal sent by a second communication device, where a first frequency domain resource used to transmit a signal sent by the first communication device is different from a second frequency domain resource used to transmit the second signal.

In this embodiment of this application, the first communication device may include a second network side device or a terminal device, the second network side device may be the network side device 12 shown in FIG. 1, and the terminal device may be the terminal 11 shown in FIG. 1. The second communication device may include an active tag device, a passive tag device, or a semi-passive tag device.

The second communication device may send the second signal to the first communication device, and the first communication device may also send the signal when necessary.

When the second communication device is an active tag device, the second communication device may actively send the second signal. For example, when the second communication device is a sensor or another device, the second communication device may actively send a second signal carrying temperature, humidity, and other measurement information. The second communication device may actively send the second signal according to pre-obtained configuration information, such as, send the second signal periodically, or send the second signal when monitored information reaches a corresponding threshold. The configuration information may be obtained when the second communication device is initialized, or sent to the second communication device after the first communication device configures the configuration information. The first communication device may alternatively send a signal before, after, or when receiving the second signal sent by the second communication device, such as, send a request signal.

When the second communication device is an active tag device, a passive tag device, or a semi-passive tag device, the first communication device may first send a first signal, and the second communication device sends the second signal based on the first signal. In other words, before the first communication device receives the second signal sent by the second communication device, the first communication device sends the first signal, and that the first communication device receives the second signal sent by the second communication device may be specifically as follows: The first communication device receives the second signal sent by the second communication device based on the first signal. The signal sent by the first communication device includes the first signal.

Specifically, the first communication device may send the first signal when necessary, such as, when goods are counted or inventory is taken. The first communication device may send the first signal within a specific range, so that the second communication device within the specific range may receive the first signal. The first signal may instruct the second communication device to transmit information.

After the first communication device sends the first signal, the second communication device may send the second signal based on the first signal in a case that the second communication device receives the first signal. The second signal may carry information to be transmitted by the second communication device.

The first frequency domain resource used to transmit the first signal is different from the second frequency domain resource used to transmit the second signal, which helps the first communication device send and receive signals at the same time on different frequency domain resources.

In a process of communication between the first communication device and the second communication device, resource configuration needs to be performed on an uplink and a downlink, and a configured resource may include:
a frequency domain resource;
a frequency domain gap;
uplink/downlink subband gap; or
a time domain resource.

The frequency domain resource may be a resource group (Resource Group, RG), a resource element (Resource Element, RE), a resource block (Resource Block, RB), a resource block group (Resource Block group, RBG), a resource element group (Resource Element Group, REG), a control channel element (Control Channel Element, CCE), a bandwidth part (Bandwidth Part, BWP), a subband, or the like. That is, the first frequency domain resource and/or the second frequency domain resource may include at least one of the foregoing.

The first communication device uses the first frequency domain resource when sending the first signal, and uses the second frequency domain resource when receiving the second signal. The first frequency domain resource is different from the second frequency domain resource, so that the first communication device is less interfered by a transmitted signal, that is, the first signal, when receiving the second signal.

According to the method provided in this embodiment of this application, the first communication device receives the second signal sent by the second communication device, where the first frequency domain resource used to transmit the signal sent by the first communication device is different from the second frequency domain resource used to transmit the second signal, to avoid or reduce interference to the first communication device caused by the signal sent by the first communication device when receiving the second signal sent by the second communication device. Therefore, the first communication device can send and receive signals at the same time, to reduce difficulty in full-duplex communication and improve signal transmission efficiency.

In an embodiment of this application, the first frequency domain resource and/or the second frequency domain resource may include at least one of the following:
contiguous frequency domain resources;
non-contiguous frequency domain resources;
an uplink frequency domain resource;
a downlink frequency domain resource;
a supplementary uplink frequency domain resource; or
a supplementary downlink frequency domain resource.

The contiguous frequency domain resources are resources that are contiguous in frequency, such as contiguous resource blocks or contiguous subbands. The non-contiguous frequency domain resources are resources that are not contiguous in frequency. For example, contiguous resource blocks are A, B, and C, and resource blocks A and C are non-contiguous resources. A supplementary uplink (Supplementary Uplink, SUL) and a supplementary downlink (Supplementary Downlink, SDL) are newly introduced bands for 5G NR to enhance uplink or downlink coverage.

The first frequency domain resource and/or the second frequency domain resource include/includes at least one of the foregoing, which helps the first communication device and the second communication device determine the frequency domain resources used to transmit the first signal and the second signal, to improve signal transmission efficiency.

In an embodiment of this application, the first frequency domain resource and/or the second frequency domain resource may be predefined, or configured by a first network side device.

That is, the first frequency domain resource and/or the second frequency domain resource may be predefined, so that the first frequency domain resource used to transmit the signal sent by the first communication device is different from the second frequency domain resource used to transmit the second signal.

The first frequency domain resource and/or the second frequency domain resource may alternatively be configured by the first network side device. According to the configuration of the first network side device, the first frequency domain resource used to transmit the signal is allocated to the signal sent by the first communication device, and the second frequency domain resource used to transmit the second signal is allocated to the second signal, and the first frequency domain resource is different from the second frequency domain resource during configuration.

The first frequency domain resource and/or the second frequency domain resource are/is determined in a predefinition manner or in a first network side device configuration manner, so that the first communication device and the second communication device can better reach a consistent understanding, to facilitate signal transmission.

In an embodiment of this application, the first signal may include control signaling and/or a first carrier signal, and the second signal may include a backscatter signal modulated based on the first carrier signal or include a signal modulated based on a second carrier signal generated by the second communication device.

In this embodiment of this application, the first communication device sends the first signal, where the first signal may include the control signaling and/or the first carrier signal. After receiving the first signal, the second communication device may send the second signal based on the first signal. The first communication device may receive the second signal.

In a case that the first signal includes the first carrier signal, after receiving the first signal, the second communication device may generate the second signal through modulation based on the first carrier signal, where the second signal includes the backscatter signal modulated based on the first carrier signal; or after receiving the first signal, the second communication device may use the first signal as a signal sending trigger condition, does not use the first carrier signal to generate the second signal through modulation, but generates the second carrier signal, and then generates the second signal through modulation based on the second carrier signal, that is, the second signal includes the signal modulated based on the second carrier signal generated by the second communication device.

In a case that the first signal does not include the first carrier signal, such as, includes only the control signaling, after receiving the first signal, the second communication device may generate the second carrier signal, and generate the second signal through modulation based on the second carrier signal, where the second signal includes the signal modulated based on the second carrier signal generated by the second communication device.

The first communication device may pre-obtain whether the second communication device has a carrier signal generation capability, and may determine, based on this, whether to send the first carrier signal.

In an embodiment of this application, a quantity of frequency domain resources corresponding to the first frequency domain resource is not equal or is equal to a quantity of frequency domain resources corresponding to the second frequency domain resource.

In this embodiment of this application, the quantity of frequency domain resources corresponding to the first frequency domain resource used to transmit the signal sent by the first communication device, such as the first signal, may not be equal to the quantity of frequency domain resources corresponding to the second frequency domain resource used to transmit the second signal.

For example, the first frequency domain resource includes a single downlink frequency domain resource, and the second frequency domain resource includes two uplink frequency domain resources. In other words, the first signal is transmitted on one downlink frequency domain resource, and the second signal is transmitted on two uplink frequency domain resources.

For another example, the first frequency domain resource includes a single uplink frequency domain resource, and the second frequency domain resource includes two downlink frequency domain resources. In other words, the first signal is transmitted on one uplink frequency domain resource, and the second signal is transmitted on two downlink frequency domain resources.

The quantity of frequency domain resources corresponding to the first frequency domain resource used to transmit the first signal may be equal to the quantity of frequency domain resources corresponding to the second frequency domain resource used to transmit the second signal.

For example, the first frequency domain resource includes a single downlink frequency domain resource, and the second frequency domain resource includes a single uplink frequency domain resource. In other words, the first signal is transmitted on one downlink frequency domain resource, and the second signal is transmitted on one uplink frequency domain resource.

For another example, the first frequency domain resource includes a single uplink frequency domain resource, and the second frequency domain resource includes a single downlink frequency domain resource. In other words, the first signal is transmitted on one uplink frequency domain resource, and the second signal is transmitted on one downlink frequency domain resource.

That the quantity of frequency domain resources corresponding to the first frequency domain resource is not equal or is equal to the quantity of frequency domain resources corresponding to the second frequency domain resource may be determined through predefinition or through configuration of the network side device.

In an embodiment of this application, the second frequency domain resource may include a single uplink frequency domain resource, and an upper sideband or a lower sideband for the second signal is suppressed; or
the second frequency domain resource may include a single downlink frequency domain resource, and an upper sideband or a lower sideband for the second signal is suppressed.

In this embodiment of this application, the second frequency domain resource used to transmit the second signal may be a single uplink frequency domain resource or a single downlink frequency domain resource. Specifically, the single uplink frequency domain resource or the single downlink frequency domain resource may be predefined, or configured by the network side device.

The second signal generated by the second communication device through modulation based on the first carrier signal sent by the first communication device or based on the second carrier signal generated by the second communication device may be a double-sideband signal. The second communication device may suppress the upper sideband or the lower sideband for the second signal.

Specifically, when the second frequency domain resource includes a single uplink frequency domain resource, the upper sideband or the lower sideband for the second signal may be suppressed, and when the second frequency domain resource includes a single downlink frequency domain resource, the upper sideband or the lower sideband for the second signal may be suppressed. That is, the second communication device may suppress the upper sideband for the second signal, and transmit the lower sideband on the single uplink frequency domain resource or the single downlink frequency domain resource, or the second communication device may suppress the lower sideband for the second signal, and transmit the upper sideband on the single uplink frequency domain resource or the single downlink frequency domain resource.

In this way, transmission of the double-sideband signal generated during modulation of the second communication device does not occupy excessive frequency domain resources, and does not cause interference to another signal transmitted on the occupied frequency domain resources.

In an embodiment of this application, before the first communication device receives the second signal sent by the second communication device based on the first signal, the method may further include the following step:

The first communication device sends image sideband suppression information to the second communication device.

In this embodiment of this application, the first communication device may send the image sideband suppression information to the second communication device. After receiving the image sideband suppression information, the second communication device may suppress, according to the image sideband suppression information, the upper sideband or the lower sideband for the second signal obtained through modulation.

For the second communication device, before the second communication device sends the second signal based on the first signal, the second communication device may receive the image sideband suppression information sent by the first communication device, and the second communication device generates the second signal based on the first signal, and then sends the second signal after performing sideband suppression on the second signal according to the image sideband suppression information.

The image sideband suppression information may be determined according to an image sideband suppression capability of the second communication device. The first communication device may pre-obtain the image sideband suppression capability of the second communication device, determine the image sideband suppression information according to the image sideband suppression capability of the second communication device, and send the image sideband suppression information to the second communication device.

Specifically, the first communication device may obtain the image sideband suppression capability of the second communication device through collection, query, or the like. For example, the image sideband suppression capability of the second communication device may be prestored in a device, and the first communication device obtains the image sideband suppression capability of the second communication device through query via the device when necessary.

The first communication device may further obtain the image sideband suppression capability of the second communication device by receiving information reported by the second communication device. For example, the second communication device may actively report the image sideband suppression capability to the first communication device, or report the image sideband suppression capability when receiving a report indication from the first communication device.

The image sideband suppression capability may include at least one of the following:
an upper sideband suppression capability;
a lower sideband suppression capability;
upper and lower sideband suppression capabilities; or
a frequency shift range suppression capability.

In this embodiment of this application, the image sideband suppression capability of the second communication device may include at least one of the foregoing.

The upper sideband suppression capability means that the second communication device has only a capability to suppress the upper sideband. In a case that the image sideband suppression capability includes the upper sideband suppression capability, the image sideband suppression information sent by the first communication device may include suppression information for the upper sideband, and the second communication device may suppress the upper sideband for the second signal according to the image sideband suppression information, and transmit the lower sideband for the second signal.

The lower sideband suppression capability means that the second communication device has only a capability to suppress the lower sideband. In a case that the image sideband suppression capability includes the lower sideband suppression capability, the image sideband suppression information sent by the first communication device may include suppression information for the lower sideband, and the second communication device may suppress the lower sideband for the second signal according to the image sideband suppression information, and transmit the upper sideband for the second signal.

The upper and lower sideband suppression capabilities mean that the second communication device has both a capability to suppress the upper sideband and a capability to suppress the lower sideband. In a case that the image sideband suppression capability includes the upper and lower sideband suppression capabilities, it indicates that the second communication device has both the capability to suppress the upper sideband and the capability to suppress the lower sideband. The image sideband suppression information sent by the first communication device may include suppression information for the upper sideband or the lower sideband. The second communication device may correspondingly suppress the upper sideband or the lower sideband for the second signal according to the image sideband suppression information, and transmit the lower sideband or the upper sideband for the second signal.

The frequency shift range suppression capability means that the second communication device has a capability to perform suppression within a frequency shift range. In a case that the image sideband suppression capability includes the frequency shift range suppression capability, the image sideband suppression information sent by the first communication device may include a frequency shift range, and the second communication device may perform sideband suppression within the frequency shift range according to the image sideband suppression information.

The first communication device sends the image sideband suppression information to the second communication device according to the image sideband suppression capability of the second communication device, which can make an indication for image sideband suppression of the second communication device more accurate, so that the second communication device can better suppress the upper sideband or the lower sideband.

In an embodiment of this application, a center frequency corresponding to the second frequency domain resource has a frequency shift relative to a center frequency corresponding to the first frequency domain resource, and the frequency shift is predefined, or indicated by the first communication device or a third communication device.

In this embodiment of this application, the first communication device sends the first signal, receives the second signal sent by the second communication device based on the first signal, where the first frequency domain resource used to transmit the first signal is different from the second frequency domain resource used to transmit the second signal. The center frequency corresponding to the second frequency domain resource has the frequency shift relative to the center frequency corresponding to the first frequency domain resource. That is, after receiving the first signal, the second communication device performs a frequency shifting operation when sending the second signal based on the first signal.

The frequency shift may be predefined, or indicated by the first communication device or the third communication device. The frequency shift may be determined according to capability information of the second communication device and then indicated. Specifically, the first communication device may determine the frequency shift according to the capability information of the second communication device, and then send indication information for the frequency shift to the second communication device, or the third communication device may determine the frequency shift according to the capability information of the second communication device, and then send indication information for the frequency shift to the second communication device.

The center frequency corresponding to the second frequency domain resource has the frequency shift relative to the center frequency corresponding to the first frequency domain resource, and the frequency shift is predefined, or indicated by the first communication device or the third communication device, to ensure that the first frequency domain resource is different from the second frequency domain resource, and reduce interference.

In an embodiment of this application, the capability information may include at least one of the following:
information for a supported modulation scheme;
frequency modulation capability information; or
bandwidth information.

In this embodiment of this application, the capability information of the second communication device may include at least one of the foregoing.

The information for the supported modulation scheme means a specific modulation scheme supported by the second communication device, for example, supporting amplitude modulation, frequency modulation, phase modulation, specifically, such as phase reversal-amplitude shift keying (Phase Reversal-Amplitude Shift Keying, PR-ASK), single side band-amplitude shift keying (Single Side Band-Amplitude Shift Keying, SSB-ASK), or double side band-amplitude shift keying (Double Side Band-Amplitude Shift Keying, DSB-ASK).

The frequency modulation capability information means a frequency modulation capability of the second communication device.

The bandwidth information means a bandwidth supported by the second communication device.

The frequency shift is determined according to the capability information of the second communication device and the frequency shift is indicated, so that the second communication device performs the frequency shifting operation according to the frequency shift, which helps make availability of the second frequency domain resource higher.

In an embodiment of this application, before the first communication device determines the frequency shift according to the capability information of the second communication device, the method may further include the following step:

The first communication device receives the capability information sent by the second communication device.

In a specific implementation, the first communication device may obtain the capability information of the second communication device through collection, query, or the like. For example, the capability information of the second communication device may be prestored in a device, and the first communication device obtains the capability information of the second communication device through query via the device when necessary.

The first communication device may further receive the capability information sent by the second communication device. For example, the second communication device may actively send the capability information to the first communication device, or report the capability information when receiving a report indication from the first communication device. That is, the second communication device may send the capability information to the first communication device before sending the second signal based on the first signal.

After receiving the capability information sent by the second communication device, the first communication device may determine the frequency shift according to the capability information of the second communication device, and send the indication information for the frequency shift to the second communication device, and the second communication device performs the frequency shifting operation according to the indication information, so that the center frequency corresponding to the second frequency domain resource used to transmit the second signal has the frequency shift with the center frequency corresponding to the first frequency domain resource used to transmit the first signal, to ensure that the first frequency domain resource is different from the second frequency domain resource, and improve signal transmission efficiency.

In an embodiment of this application, a guard band is configured between the first frequency domain resource and the second frequency domain resource, and a size of the guard band is determined according to the capability information.

In this embodiment of this application, the guard band is configured between the first frequency domain resource and the second frequency domain resource, to reduce signal interference between different frequency domain resources. The size of the guard band is determined according to the capability information of the second communication device, to ensure that the size of the guard band can be reached between the first frequency domain resource and the second frequency domain resource.

In an embodiment of this application, in a case that the first communication device includes the terminal device, the first frequency domain resource may be indicated by the third communication device.

In this embodiment of this application, the first communication device may include the second network side device or the terminal device. In a case that the first communication device includes the terminal device, the first frequency domain resource may be indicated by the third communication device. The first communication device may transmit the first signal on the first frequency domain resource according to the indication of the third communication device, to improve availability of the first frequency domain resource.

In an embodiment of this application, the second communication device receives the first signal sent by the first communication device, and sends the second signal based on the first signal. Specifically, the second communication device may send the second signal to the first communication device based on the first signal, so that the first communication device may receive the second signal. Alternatively, the second communication device may send the second signal to the third communication device based on the first signal, that is, the first communication device sends the first signal to the second communication device, the second communication device sends the second signal to the third communication device based on the first signal, and the first communication device serves as an auxiliary device of the third communication device, so that the third communication device can obtain the second signal. The third communication device may include a third network side device.

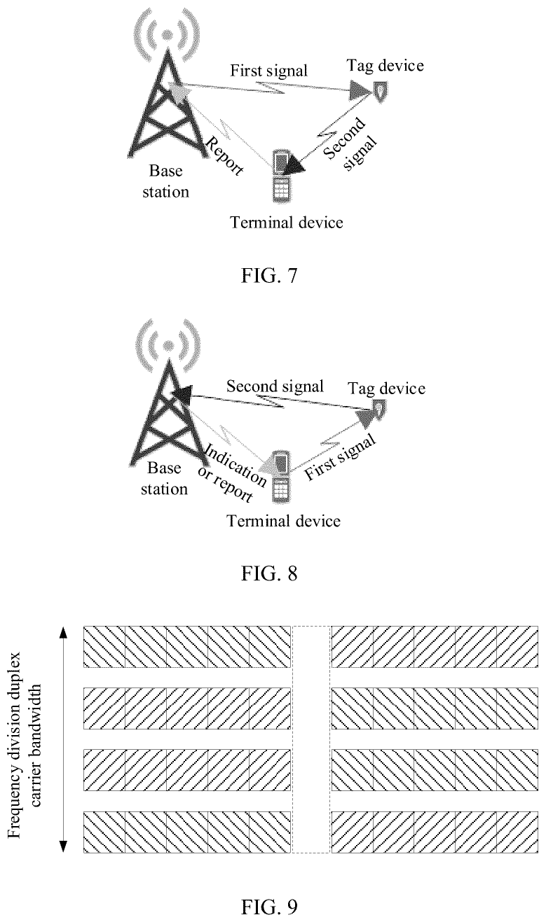

In other words, in this embodiment of this application, in a backscatter communication scenario, there may be the following four cases:
(1) As shown in FIG. 5, the first communication device is the second network side device, such as a base station, and the second communication device is the tag device. The base station serves as a reader to communicate with the tag device, and the base station sends the first signal to the tag device. The first signal may include the control signaling and/or the first carrier signal. The tag device generates the second signal based on the first signal, and sends the second signal to the base station.
(2) As shown in FIG. 6, the first communication device is the terminal device, and the second communication device is the tag device. The terminal device serves as a reader to communicate with the tag device. The base station may send an operating indication to the terminal device, and the terminal device sends the first signal to the tag device. The first signal may include the control signaling and/or the first carrier signal. The tag device generates the second signal based on the first signal, and sends the second signal to the terminal device.
(3) As shown in FIG. 7, the first communication device is the second network side device, such as a base station, the second communication device is the tag device, and the third communication device is the terminal device. The base station sends the first signal to the tag device. The first signal may include the control signaling and/or the first carrier signal. The tag device generates the second signal based on the first signal, and sends the second signal to the terminal device. The terminal device reports related information carried in the second signal to the base station.
(4) As shown in FIG. 8, the first communication device is the terminal device, the second communication device is the tag device, and the third communication device is the third network side device, such as a base station. The base station sends an operating indication to the terminal device, and the terminal device sends the first signal to the tag device. The first signal may include the control signaling and/or the first carrier signal. The tag device generates the second signal based on the first signal, sends the second signal to the base station. The base station reports related information carried in the second signal to the terminal device.

It should be noted that types of the first network side device, the second network side device, and the third network side device, such as the base station, include but are not limited to an integrated access and backhaul node (Integrated Access and Backhaul node, IAB node), a repeater (repeater), and a pole station (pole station), and the repeater is, for example, a network-controlled repeater (network controlled repeater).

For ease of understanding, the technical solutions provided in the embodiments of this application is further described by using a specific example in a backscatter communication system.

In a specific example, the second frequency domain resource used to transmit the second signal includes two uplink frequency domain resources or two downlink frequency domain resources, that is, the second signal is transmitted on the two uplink/downlink frequency domain resources. This example may be for a scenario in which the second communication device does not have the image sideband suppression capability. In this example, the second communication device is the tag device.

As shown in FIG. 9, resource configuration may be performed on the backscatter communication system in a predefinition manner or in a network side device configuration manner. Specific resource configuration parameters are shown as follows:
two downlink frequency domain resources (such as a part filled with right slashes) and two uplink frequency domain resources (such as a part filled with left slashes);
a quantity of subbands/contiguous resource blocks/resource elements in a frequency domain resource;
different downlink/uplink subband gaps (guardband); and
a time domain resource, such as N symbols (symbol).

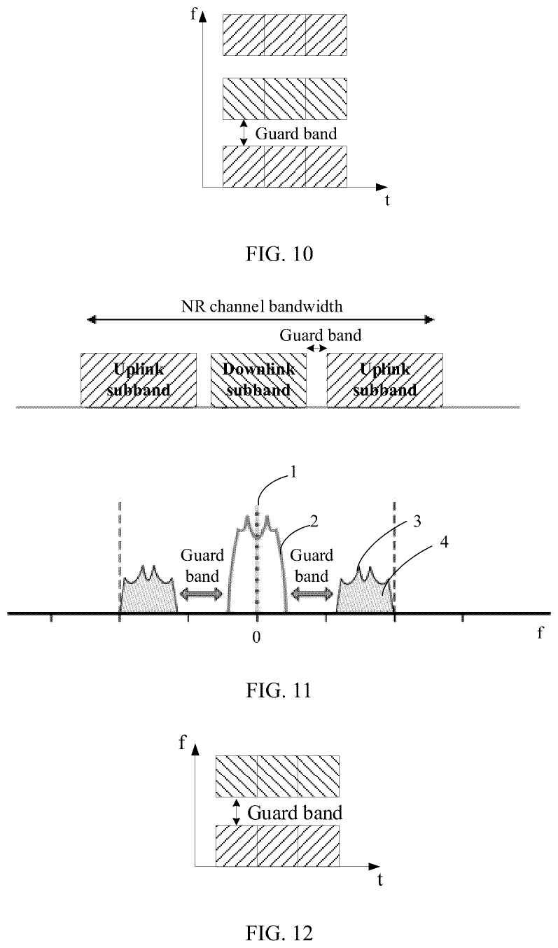

A specific transmission process is described with reference to FIG. 10 and FIG. 11. First, a reader sends control signaling and a first carrier signal, such as a continuous wave of 900 MHz, in a downlink subband of an NR channel, and then a tag device receives the control signaling and the first carrier signal sent by the reader. The tag device parses the control signaling in a manner similar to envelope detection, to obtain an indication for a frequency shift (guardband) of 20 MHz. The tag device modulates to-be-sent bit data to the first carrier signal in a PR-ASK modulation scheme to obtain a backscatter signal, and then shifts a frequency of the backscatter signal to two uplink subbands for reflection. The reader receives the backscatter signal in the two uplink subbands. 1 in FIG. 11 represents the first carrier signal, 2 represents a reader-modulated signal, 3 represents the backscatter signal responded to by the tag device, and 4 represents a main sideband. Reader modulation means that the PR-ASK modulation scheme or an SSB-ASK modulation scheme may be used.

It is assumed that a carrier frequency of the first carrier signal sent by the reader is 900 MHZ, and center frequencies of the backscatter signal obtained after the tag device performs frequency shifting are 880 MHz and 920 MHz respectively. Brought benefits are as follows:

The carrier signal may be sent at different frequencies at the same time, and intra-frequency interference caused by carrier leakage at a transmitting end on the backscatter signal at a receiving end can be avoided. Because energy of the backscatter signal is much lower than energy of the carrier signal, the backscatter signal is susceptible to interference.

880 MHz and 920 MHz are frequency division duplex band (FDD band) transmission resources configured by the network side device, and the backscatter signal after frequency shifting is not susceptible to interference.

In addition, the reader receives backscatter signals in two sidebands, and may recover, through double detection, the bit data sent by the tag device, to improve detection performance.

In the foregoing example, a channel corresponding to the downlink subband is used to transmit the carrier signal, and a channel corresponding to the two uplink subbands is used to transmit the backscatter signal. Similarly, a channel corresponding to the uplink subband may be used to transmit the carrier signal, and a channel corresponding to the two downlink subbands may be used to transmit the backscatter signal. The process is not repeated.

In another specific example, the second frequency domain resource used to transmit the second signal includes a single uplink frequency domain resource or a single downlink frequency domain resource, that is, the second signal is transmitted on one uplink/downlink frequency domain resource. This example may be for a scenario in which the second communication device has the image sideband suppression capability. In this example, the second communication device is the tag device.

The tag device may report an image sideband suppression capability of the tag device. The reader may configure a frequency domain resource for backscatter communication according to the image sideband suppression capability reported by the tag device, as shown in FIG. 12.

First, the reader sends control signaling and a first carrier signal, such as a continuous wave of 900 MHz, in a downlink subband of an NR channel, and then the tag device receives the control signaling and the first carrier signal sent by the reader. The tag device parses the control signaling in a manner that is similar to envelope detection, to obtain an indication for a frequency shift (guardband) of 20 MHz. The tag device modulates to-be-sent bit data to the first carrier signal in a PR-ASK modulation scheme to obtain a backscatter signal, and then shifts a frequency of the backscatter signal to two uplink subbands. A high-frequency subband is suppressed by using an image sideband suppression circuit, and the backscatter signal is transmitted only in a low-frequency uplink subband, and the reader receives the backscatter signal in the low-frequency uplink subband. Alternatively, a low-frequency subband is suppressed by using an image sideband suppression circuit, the backscatter signal is transmitted only in a high-frequency uplink subband, and the reader receives the backscatter signal in the high-frequency uplink subband.

It is assumed that a carrier frequency of the first carrier signal sent by the reader is 900 MHz, and a center frequency of the backscatter signal obtained after the tag device performs frequency shifting is 880 MHz. Brought benefits are as follows:

The carrier signal is sent at different frequencies at the same time, and intra-frequency interference caused by carrier leakage at a transmitting end to the backscatter signal at a receiving end is avoided. Because energy of the backscatter signal is much lower than energy of the carrier signal, the backscatter signal is more susceptible to interference.

880 MHz is frequency division duplex band (FDD band) transmission resource configured by the network side device, and the backscatter signal after frequency shifting is not susceptible to interference.

Spectral efficiency can be improved through image sideband suppression of the tag device.

In the foregoing example, a channel corresponding to the downlink subband is used to transmit the carrier signal, and a channel corresponding to the uplink subband is used to transmit the backscatter signal. Similarly, the uplink subband may be used to transmit the carrier signal, and the downlink subband may be used to transmit the backscatter signal. The process is not repeated.

In this embodiment of this application, uplink and downlink transmission resources in the backscatter communication system can be flexibly configured to dynamically indicate that the backscatter signal is transmitted in different subbands/resource blocks/resource elements, which is not managed and controlled by the frequency division duplex band, to effectively avoid intra-frequency self-interference. Even considering a double-sideband reflection signal, frequency division duplex band resources can be flexibly configured to effectively avoid interference to another channel. In addition, the reader may perform double detection on the backscatter signal to obtain more reliable detection performance.

The signal transmission method provided in the embodiments of this application may be performed by a signal transmission apparatus. The signal transmission apparatus provided in the embodiments of this application is described by using an example in which the signal transmission apparatus performs the signal transmission method in the embodiments of this application.

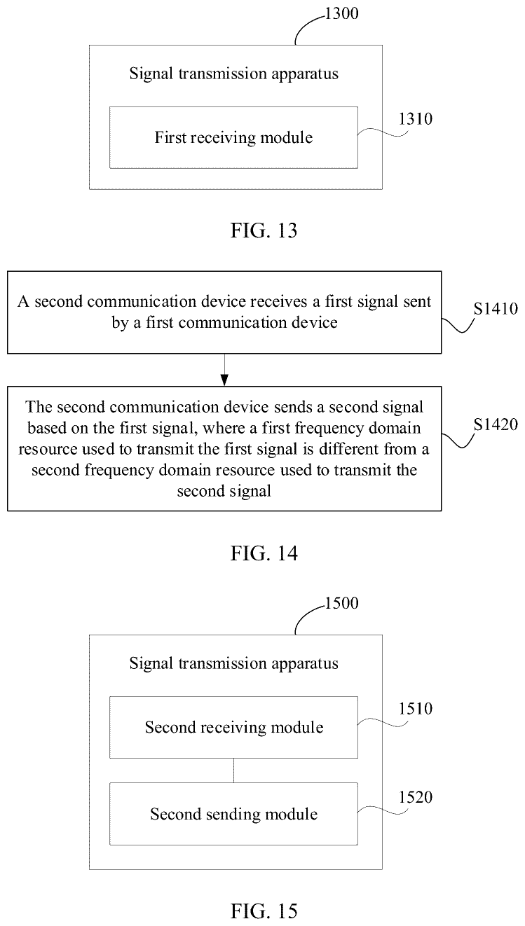

As shown in FIG. 13, a signal transmission apparatus 1300 may include the following module.

A first receiving module 1310 is configured to receive a second signal sent by a second communication device, where
a first frequency domain resource used to transmit a signal sent by a first communication device is different from a second frequency domain resource used to transmit the second signal.

The apparatus provided in this embodiment of this application is configured to receive the second signal sent by the second communication device, where the first frequency domain resource used to transmit the signal sent by the first communication device is different from the second frequency domain resource used to transmit the second signal, to avoid or reduce interference caused by a transmitted signal when the second signal sent by the second communication device is received. Therefore, signals can be sent and received at the same time, to reduce difficulty in full-duplex communication and improve signal transmission efficiency.

In a specific implementation of this application, the signal transmission apparatus 1300 further includes a first sending module, configured to:
send a first signal.

The first receiving module 1310 is further configured to receive the second signal sent by the second communication device based on the first signal.

In a specific implementation of this application, the first frequency domain resource and/or the second frequency domain resource include/includes at least one of the following:
contiguous frequency domain resources;
non-contiguous frequency domain resources;
an uplink frequency domain resource;
a downlink frequency domain resource;
a supplementary uplink frequency domain resource; or
a supplementary downlink frequency domain resource; or
the first frequency domain resource and/or the second frequency domain resource include/includes at least one of the following:
a resource group, a resource element, a resource block, a resource block group, a resource element group, a control channel element, a bandwidth part, or a subband.

In a specific implementation of this application, the first frequency domain resource and/or the second frequency domain resource are/is predefined, or configured by a first network side device.

In a specific implementation of this application, the first signal includes control signaling and/or a first carrier signal, and the second signal includes a backscatter signal modulated based on the first carrier signal or includes a signal modulated based on a second carrier signal generated by the second communication device.

In a specific implementation of this application, a quantity of frequency domain resources corresponding to the first frequency domain resources is not equal or is equal to a quantity of frequency domain resources corresponding to the second frequency domain resources.

In a specific implementation of this application, the second frequency domain resource includes a single uplink frequency domain resource, and an upper sideband or a lower sideband for the second signal is suppressed; or
the second frequency domain resource includes a single downlink frequency domain resource, and an upper sideband or a lower sideband for the second signal is suppressed.

In a specific implementation of this application, the first sending module is further configured to:
before the second signal sent by the second communication device based on the first signal is received, send image sideband suppression information to the second communication device.

In a specific implementation of this application, the image sideband suppression information is determined according to an image sideband suppression capability of the second communication device.

In a specific implementation of this application, the image sideband suppression capability includes at least one of the following:
an upper sideband suppression capability;
a lower sideband suppression capability;
upper and lower sideband suppression capabilities; or
a frequency shift range suppression capability.

In a specific implementation of this application, a center frequency corresponding to the second frequency domain resource has a frequency shift relative to a center frequency corresponding to the first frequency domain resource, and the frequency shift is predefined, or indicated by the first communication device or a third communication device.

In a specific implementation of this application, the frequency shift is indicated by the first communication device, and the signal transmission apparatus 1300 further includes:
a determining module, configured to determine the frequency shift according to capability information of the second communication device.

The first sending module is further configured to send indication information for the frequency shift to the second communication device.

In a specific implementation of this application, the capability information includes at least one of the following:
information for a supported modulation scheme;
frequency modulation capability information; or
bandwidth information.

In a specific implementation of this application, a second receiving module 1320 is further configured to:
before the frequency shift is determined according to the capability information of the second communication device, receive the capability information sent by the second communication device.

In a specific implementation of this application, a guard band is configured between the first frequency domain resource and the second frequency domain resource, and a size of the guard band is determined according to the capability information.

In a specific implementation of this application, the first communication device includes a second network side device or a terminal device.

In a specific implementation of this application, the second communication device includes an active tag device, a passive tag device, or a semi-passive tag device.

The signal transmission apparatus 1300 provided in this embodiment of this application can implement the processes implemented in the method embodiment shown in FIG. 4, and a same technical effect can be achieved. To avoid repetition, details are not described herein again.

Corresponding to the method embodiment shown in FIG. 4, an embodiment of this application further provides a signal transmission method. As shown in FIG. 14, the method may include the following steps:

S1410: A second communication device receives a first signal sent by a first communication device.

S1420: The second communication device sends a second signal based on the first signal, where a first frequency domain resource used to transmit the first signal is different from a second frequency domain resource used to transmit the second signal.

According to the method provided in this embodiment of this application, the second communication device receives the first signal sent by the first communication device and sends the second signal based on the first signal, where the first frequency domain resource used to transmit the first signal is different from the second frequency domain resource used to transmit the second signal, to avoid or reduce interference to a receiver caused by the first signal when receiving the second signal sent by the second communication device. Therefore, signals can be sent and received at the same time, to reduce difficulty in full-duplex communication and improve signal transmission efficiency.

In a specific implementation of this application, the first frequency domain resource and/or the second frequency domain resource include/includes at least one of the following:
contiguous frequency domain resources;
non-contiguous frequency domain resources;
an uplink frequency domain resource;
a downlink frequency domain resource;
a supplementary uplink frequency domain resource; or
a supplementary downlink frequency domain resource; or
the first frequency domain resource and/or the second frequency domain resource include/includes at least one of the following:
a resource group, a resource element, a resource block, a resource block group, a resource element group, a control channel element, a bandwidth part, or a subband.

In a specific implementation of this application, the first frequency domain resource and/or the second frequency domain resource are/is predefined, or configured by a first network side device.

In a specific implementation of this application, the first signal includes control signaling and/or a first carrier signal, and the second signal includes a backscatter signal modulated based on the first carrier signal or includes a signal modulated based on a second carrier signal generated by the second communication device.

In a specific implementation of this application, a quantity of frequency domain resources corresponding to the first frequency domain resources is not equal or is equal to a quantity of frequency domain resources corresponding to the second frequency domain resources.

In a specific implementation of this application, the second frequency domain resource includes a single uplink frequency domain resource, and an upper sideband or a lower sideband for the second signal is suppressed; or
the second frequency domain resource includes a single downlink frequency domain resource, and an upper sideband or a lower sideband for the second signal is suppressed.

In a specific implementation of this application, before the second communication device sends the second signal based on the first signal, the method further includes:

The second communication device receives image sideband suppression information sent by the first communication device.

That the second communication device sends a second signal based on the first signal includes:

The second communication device generates the second signal based on the first signal.

The second communication device sends the second signal after performing sideband suppression on the second signal according to the image sideband suppression information.

In a specific implementation of this application, the image sideband suppression information is determined according to an image sideband suppression capability of the second communication device.

In a specific implementation of this application, the image sideband suppression capability includes at least one of the following:
an upper sideband suppression capability;
a lower sideband suppression capability;
upper and lower sideband suppression capabilities; or
a frequency shift range suppression capability.

In a specific implementation of this application, a center frequency corresponding to the second frequency domain resource has a frequency shift relative to a center frequency corresponding to the first frequency domain resource, and the frequency shift is predefined, or indicated by the first communication device or a third communication device.

In a specific implementation of this application, the frequency shift is indicated by the first communication device or the third communication device, and the method may further include the following step:

The second communication device receives indication information for the frequency shift from the first communication device or the third communication device.

In a specific implementation of this application, before the second communication device receives the indication information for the frequency shift from the first communication device or the third communication device, the method further includes:

The second communication device sends capability information to the first communication device or the third communication device, where the capability information is used to determine the frequency shift.

In a specific implementation of this application, the capability information includes at least one of the following:
information for a supported modulation scheme;
frequency modulation capability information; or
bandwidth information.

In a specific implementation of this application, a guard band is configured between the first frequency domain resource and the second frequency domain resource, and a size of the guard band is determined according to the capability information.

In a specific implementation of this application, the first communication device includes a second network side device or a terminal device.

In a specific implementation of this application, the second communication device includes an active tag device, a passive tag device, or a semi-passive tag device.

In a specific implementation of this application, that the second communication device sends a second signal based on the first signal includes:

The second communication device sends the second signal to the first communication device based on the first signal; or
the second communication device sends the second signal to a third communication device based on the first signal.

In a specific implementation of this application, in a case that the second communication device sends the second signal to the first communication device based on the first signal, and the first communication device includes the terminal device, the first frequency domain resource is indicated by the third communication device.

For a specific implementation process of the signal transmission method provided in this embodiment of this application, refer to the specific implementation process in the method embodiment shown in FIG. 4. A same technical effect can be achieved. To avoid repetition, details are not described herein again.

The signal transmission method provided in the embodiments of this application may be performed by a signal transmission apparatus. The signal transmission apparatus provided in the embodiments of this application is described by using an example in which the signal transmission apparatus performs the signal transmission method in the embodiments of this application.

As shown in FIG. 15, a signal transmission apparatus 1500 may include the following module.

A second receiving module 1510 is configured to receive a first signal sent by a first communication device.

A second sending module 1520 is configured to send a second signal based on the first signal, where
a first frequency domain resource used to transmit the first signal is different from a second frequency domain resource used to transmit the second signal.

The apparatus provided in this embodiment of this application is configured to receive the first signal sent by the first communication device, and send the second signal based on the first signal, where the first frequency domain resource used to transmit the first signal is different from the second frequency domain resource used to transmit the second signal, to avoid or reduce interference to a receiver caused by the first signal when receiving the second signal sent by the second communication device. Therefore, signals can be sent and received at the same time, to reduce difficulty in full-duplex communication and improve signal transmission efficiency.

In a specific implementation of this application, the first frequency domain resource and/or the second frequency domain resource include/includes at least one of the following:
contiguous frequency domain resources;
non-contiguous frequency domain resources;
an uplink frequency domain resource;
a downlink frequency domain resource;
a supplementary uplink frequency domain resource; or
a supplementary downlink frequency domain resource; or
the first frequency domain resource and/or the second frequency domain resource include/includes at least one of the following:
a resource group, a resource element, a resource block, a resource block group, a resource element group, a control channel element, a bandwidth part, or a subband.

In a specific implementation of this application, the first frequency domain resource and/or the second frequency domain resource are/is predefined, or configured by a first network side device.

In a specific implementation of this application, the first signal includes control signaling and/or a first carrier signal, and the second signal includes a backscatter signal modulated based on the first carrier signal or includes a signal modulated based on a second carrier signal generated by the second communication device.

In a specific implementation of this application, a quantity of frequency domain
resources corresponding to the first frequency domain resources is not equal or is equal to a quantity of frequency domain resources corresponding to the second frequency domain resources.

In a specific implementation of this application, the second frequency domain resource includes a single uplink frequency domain resource, and an upper sideband or a lower sideband for the second signal is suppressed; or
the second frequency domain resource includes a single downlink frequency domain resource, and an upper sideband or a lower sideband for the second signal is suppressed.

In a specific implementation of this application, the second receiving module 1510 is further configured to:
before the second signal is sent based on the first signal, receive image sideband suppression information sent by the first communication device.

The second sending module 1520 is further configured to:
generate the second signal based on the first signal; and
send the second signal after performing sideband suppression on the second signal according to the image sideband suppression information.

In a specific implementation of this application, the image sideband suppression information is determined according to an image sideband suppression capability of the second communication device.

In a specific implementation of this application, the image sideband suppression capability includes at least one of the following:
an upper sideband suppression capability;
a lower sideband suppression capability;
upper and lower sideband suppression capabilities; or
a frequency shift range suppression capability.

In a specific implementation of this application, a center frequency corresponding to the second frequency domain resource has a frequency shift relative to a center frequency corresponding to the first frequency domain resource, and the frequency shift is predefined, or indicated by the first communication device or a third communication device.

In a specific implementation of this application, the frequency shift is indicated by the first communication device or the third communication device, and the second receiving module 1510 is further configured to:
receive indication information for the frequency shift from the first communication device or the third communication device.

In a specific implementation of this application, the second sending module 1520 is further configured to:
before the indication information for the frequency shift is received from the first communication device or the third communication device, send capability information to the first communication device or the third communication device, where the capability information is used to determine the frequency shift.

In a specific implementation of this application, the capability information includes at least one of the following:
information for a supported modulation scheme;
frequency modulation capability information; or
bandwidth information.

In a specific implementation of this application, a guard band is configured between the first frequency domain resource and the second frequency domain resource, and a size of the guard band is determined according to the capability information.

In a specific implementation of this application, the first communication device includes a second network side device or a terminal device.

In a specific implementation of this application, the second communication device includes an active tag device, a passive tag device, or a semi-passive tag device.

In a specific implementation of this application, the second sending module 1520 is configured to:
send the second signal to the first communication device based on the first signal; or
send the second signal to a third communication device based on the first signal.

In a specific implementation of this application, in a case that the second communication device sends the second signal to the first communication device based on the first signal, and the first communication device includes the terminal device, the first frequency domain resource is indicated by the third communication device.

The signal transmission apparatus 1500 provided in this embodiment of this application can implement the processes implemented in the method embodiment shown in FIG. 14, and a same technical effect can be achieved. To avoid repetition, details are not described herein again.

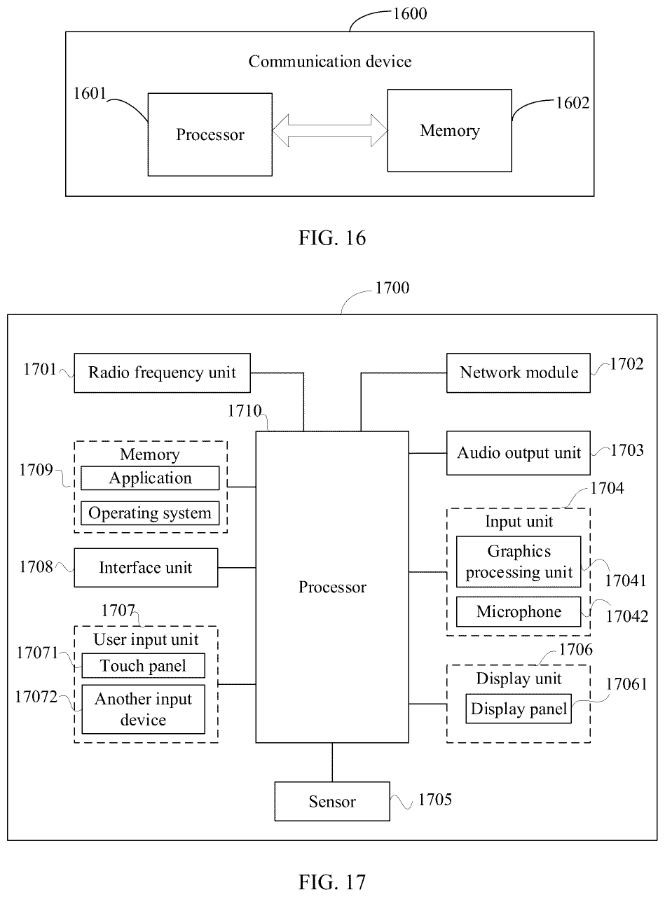

As shown in FIG. 16, an embodiment of this application further provides a communication device 1600, including a processor 1601 and a memory 1602. The memory 1602 stores a program or an instruction that is executable on the processor 1601. The program or the instruction is executed by the processor 1601 to implement the steps of the foregoing embodiment of the signal transmission method, and a same technical effect can be achieved. The communication device 1600 may be a network side device or a terminal device.

Specifically, FIG. 17 is a schematic diagram of a structure of a terminal device according to an embodiment of this application.

The terminal device 1700 includes but is not limited to at least a part of components such as a radio frequency unit 1701, a network module 1702, an audio output unit 1703, an input unit 1704, a sensor 1705, a display unit 1706, a user input unit 1707, an interface unit 1708, a memory 1709, and a processor 1710.

It can be understood by a person skilled in the art that the terminal device 1700 may further include a power supply (such as a battery) that supplies power to each component. The power supply may be logically connected to the processor 1710 by using a power management system, to implement functions such as charging, discharging, and power consumption management by using the power management system. The terminal device structure shown in FIG. 17 constitutes no limitation on the terminal device, and the terminal device may include more or fewer components than those shown in the figure, or combine some components, or have different component arrangements. Details are not described herein.

It should be understood that in this embodiment of this application, the input unit 1704 may include a graphics processing unit (Graphics Processing Unit, GPU) 17041 and a microphone 17042. The graphics processing unit 17041 processes image data of a static picture or a video obtained by an image capture apparatus (for example, a camera) in a video capture mode or an image capture mode. The display unit 1706 may include a display panel 17061, and the display panel 17061 may be configured in a form of a liquid crystal display, an organic light-emitting diode, or the like. The user input unit 1707 includes at least one of a touch panel 17071 and another input device 17072. The touch panel 17071 is also referred to as a touchscreen. The touch panel 17071 may include two parts: a touch detection apparatus and a touch controller. The another input device 17072 may include but is not limited to a physical keyboard, a functional button (such as a volume control button or a power on/off button), a trackball, a mouse, and a joystick. Details are not described herein.

In this embodiment of this application, after receiving downlink data from a network side device, the radio frequency unit 1701 may transmit the downlink data to the processor 1710 for processing. In addition, the radio frequency unit 1701 may send uplink data to the network side device. Generally, the radio frequency unit 1701 includes but is not limited to an antenna, an amplifier, a transceiver, a coupler, a low noise amplifier, a duplexer, and the like.

The memory 1709 may be configured to store a software program or an instruction and various data. The memory 1709 may mainly include a first storage area for storing a program or an instruction and a second storage area for storing data. The first storage area may store an operating system, and an application or an instruction required by at least one function (for example, a sound playing function or an image playing function). In addition, the memory 1709 may be a volatile memory or a non-volatile memory, or the memory 1709 may include a volatile memory and a non-volatile memory. The non-volatile memory may be a read-only memory (Read-Only Memory, ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (Random Access Memory, RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synch link dynamic random access memory (Synch link DRAM, SLDRAM), and a direct rambus random access memory (Direct Rambus RAM, DRRAM). The memory 1709 in this embodiment of this application includes but is not limited to these memories and any memory of another proper type.

The processor 1710 may include one or more processing units. Optionally, an application processor and a modem processor are integrated into the processor 1710. The application processor mainly processes an operating system, a user interface, an application, or the like. The modem processor mainly processes a wireless communication signal, for example, a baseband processor. It may be understood that, alternatively, the modem processor may not be integrated into the processor 1710.

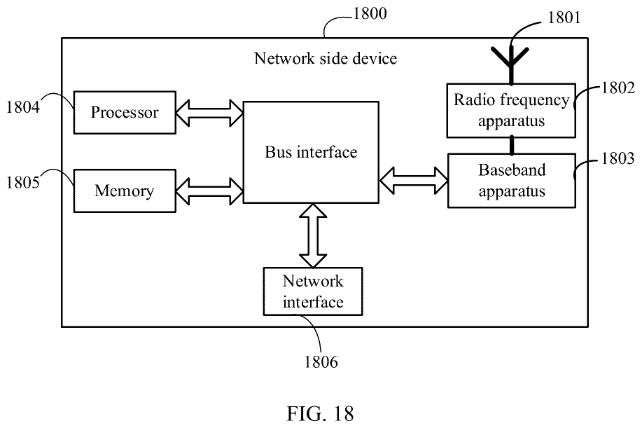

Specifically, FIG. 18 is a schematic diagram of a structure of a network side device according to an embodiment of this application.

The network side device 1800 includes an antenna 1801, a radio frequency apparatus 1802, a baseband apparatus 1803, a processor 1804, and a memory 1805. The antenna 1801 is connected to the radio frequency apparatus 1802. In an uplink direction, the radio frequency apparatus 1802 receives information through the antenna 1801, and sends the received information to the baseband apparatus 1803 for processing. In a downlink direction, the baseband apparatus 1803 processes information that needs to be sent, and sends processed information to the radio frequency apparatus 1802. The radio frequency apparatus 1802 processes the received information, and sends processed information through the antenna 1801.

In the foregoing embodiment, the method performed by the network side device may be implemented in the baseband apparatus 1803. The baseband apparatus 1803 includes a baseband processor.

For example, the baseband apparatus 1803 may include at least one baseband board. A plurality of chips are disposed on the baseband board. As shown in FIG. 180, one chip is, for example, a baseband processor, and is connected to the memory 1805 by using a bus interface, to invoke a program in the memory 1805 to perform the operations of the network device shown in the foregoing method embodiment.

The network side device may further include a network interface 1806, and the interface is, for example, a common public radio interface (common public radio interface, CPRI).

Specifically, the network side device 1800 in this embodiment of the present invention further includes an instruction or a program that is stored in the memory 1805 and that is executable on the processor 1804. The processor 1804 invokes the instruction or the program in the memory 1805 to perform the method performed by the foregoing modules, and a same technical effect is achieved. To avoid repetition, details are not described herein again.

An embodiment of this application further provides a readable storage medium. The readable storage medium stores a program or an instruction. The program or the instruction is executed by a processor to implement the processes of the method embodiment shown in FIG. 4 or the processes of the method embodiment shown in FIG. 14, and a same technical effect can be achieved. To avoid repetition, details are not described herein again.

The processor is a processor in the terminal in the foregoing embodiments. The readable storage medium includes a computer-readable storage medium, such as a computer read-only memory ROM, a random access memory RAM, a magnetic disk, or an optical disc.

An embodiment of this application further provides a computer program/program product. The computer program/program product is stored in a storage medium. The computer program/program product is executed by at least one processor to implement the processes of the method embodiment shown in FIG. 4 or the processes of the method embodiment shown in FIG. 14, and a same technical effect can be achieved. To avoid repetition, details are not described herein again.

An embodiment of this application further provides a communication system, including a first communication device and a second communication device. The first communication device may be configured to perform the steps of the method embodiment shown in FIG. 4, and the second communication device may be configured to perform the steps of the method embodiment shown in FIG. 14.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the method and the apparatus in the embodiments of this application is not limited to performing functions in an illustrated or discussed sequence, and may further include performing functions in a basically simultaneous manner or in a reverse sequence according to the functions concerned. For example, the described method may be performed in an order different from that described, and the steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. In most circumstances, the former is a preferred implementation. Based on such an understanding, the technical solutions of this application essentially or the part contributing to the prior art may be implemented in a form of a computer software product. The computer software product is stored in a storage medium (for example, a ROM/RAM, a floppy disk, or an optical disc), and includes several instructions for instructing a terminal (which may be a mobile phone, a computer, a server, an air conditioner, a network device, or the like) to perform the methods described in the embodiments of this application.

The embodiments of this application are described above with reference to the accompanying drawings, but this application is not limited to the foregoing specific implementations, and the foregoing specific implementations are only illustrative and not restrictive. Under the enlightenment of this application, a person of ordinary skill in the art can make many forms without departing from the purpose of this application and the protection scope of the claims, all of which fall within the protection of this application.

1. A signal transmission method, comprising:
receiving, by a first communication device, a second signal sent by a second communication device, wherein
a first frequency domain resource used to transmit a signal sent by the first communication device is different from a second frequency domain resource used to transmit the second signal.

2. The method according to claim 1, wherein before the receiving, by a first communication device, a second signal sent by a second communication device, the method further comprises:
sending, by the first communication device, a first signal; and
the receiving, by a first communication device, a second signal sent by a second communication device comprises:
receiving, by the first communication device, the second signal sent by the second communication device based on the first signal.

3. The method according to claim 1, wherein the first frequency domain resource and/or the second frequency domain resource comprise/comprises at least one of the following:
contiguous frequency domain resources,
non-contiguous frequency domain resources,
an uplink frequency domain resource,
a downlink frequency domain resource,
a supplementary uplink frequency domain resource, or
a supplementary downlink frequency domain resource; or
wherein the first frequency domain resource and/or the second frequency domain resource comprise/comprises at least one of the following:
a resource group, a resource element, a resource block, a resource block group, a resource element group, a control channel element, a bandwidth part, or a subband.

4. The method according to claim 2, wherein the first signal comprises control signaling and/or a first carrier signal, and the second signal comprises a backscatter signal modulated based on the first carrier signal or comprises a signal modulated based on a second carrier signal generated by the second communication device.

5. The method according to claim 1, wherein a quantity of frequency domain resources corresponding to the first frequency domain resources is not equal or is equal to a quantity of frequency domain resources corresponding to the second frequency domain resources.

6. The method according to claim 2, wherein the second frequency domain resource comprises a single uplink frequency domain resource, and an upper sideband or a lower sideband for the second signal is suppressed; or
the second frequency domain resource comprises a single downlink frequency domain resource, and an upper sideband or a lower sideband for the second signal is suppressed.

7. The method according to claim 6, wherein before the receiving, by the first communication device, the second signal sent by the second communication device based on the first signal, the method further comprises:
sending, by the first communication device, image sideband suppression information to the second communication device.

8. The method according to claim 2, wherein a center frequency corresponding to the second frequency domain resource has a frequency shift relative to a center frequency corresponding to the first frequency domain resource, and the frequency shift is predefined, or indicated by the first communication device or a third communication device.

9. The method according to claim 8, wherein the frequency shift is indicated by the first communication device, and the method further comprises:
determining, by the first communication device, the frequency shift according to capability information of the second communication device; and
sending, by the first communication device, indication information for the frequency shift to the second communication device.

10. A signal transmission method, comprising:
receiving, by a second communication device, a first signal sent by a first communication device; and
sending, by the second communication device, a second signal based on the first signal, wherein
a first frequency domain resource used to transmit the first signal is different from a second frequency domain resource used to transmit the second signal.

11. The method according to claim 10, wherein the first frequency domain resource and/or the second frequency domain resource comprise/comprises at least one of the following:
contiguous frequency domain resources,
non-contiguous frequency domain resources,
an uplink frequency domain resource,
a downlink frequency domain resource,
a supplementary uplink frequency domain resource, or
a supplementary downlink frequency domain resource; or
wherein the first frequency domain resource and/or the second frequency domain resource comprise/comprises at least one of the following:
a resource group, a resource element, a resource block, a resource block group, a resource element group, a control channel element, a bandwidth part, or a subband.

12. The method according to claim 10, wherein the first signal comprises control signaling and/or a first carrier signal, and the second signal comprises a backscatter signal modulated based on the first carrier signal or comprises a signal modulated based on a second carrier signal generated by the second communication device.

13. The method according to claim 10, wherein a quantity of frequency domain resources corresponding to the first frequency domain resources is not equal or is equal to a quantity of frequency domain resources corresponding to the second frequency domain resources.

14. The method according to claim 10, wherein the second frequency domain resource comprises a single uplink frequency domain resource, and an upper sideband or a lower sideband for the second signal is suppressed; or
the second frequency domain resource comprises a single downlink frequency domain resource, and an upper sideband or a lower sideband for the second signal is suppressed.

15. The method according to claim 14, wherein before the sending, by the second communication device, a second signal based on the first signal, the method further comprises:
receiving, by the second communication device, image sideband suppression information sent by the first communication device; and
the sending, by the second communication device, a second signal based on the first signal comprises:
generating, by the second communication device, the second signal based on the first signal; and
sending, by the second communication device, the second signal after performing sideband suppression on the second signal according to the image sideband suppression information.

16. The method according to claim 10, wherein a center frequency corresponding to the second frequency domain resource has a frequency shift relative to a center frequency corresponding to the first frequency domain resource, and the frequency shift is predefined, or indicated by the first communication device or a third communication device.

17. The method according to claim 16, wherein the frequency shift is indicated by the first communication device or the third communication device, and the method further comprises:
receiving, by the second communication device, indication information for the frequency shift from the first communication device or the third communication device.

18. The method according to claim 17, wherein before the receiving, by the second communication device, indication information for the frequency shift from the first communication device or the third communication device, the method further comprises:
sending, by the second communication device, capability information to the first communication device or the third communication device, wherein the capability information is used to determine the frequency shift.

19. A first communication device, comprising a processor and a memory, wherein the memory stores a program or an instruction that is executable on the processor, and the program or the instruction is executed by the processor to implement a signal transmission method, the signal transmission method comprising:
receiving, by the first communication device, a second signal sent by a second communication device, wherein
a first frequency domain resource used to transmit a signal sent by the first communication device is different from a second frequency domain resource used to transmit the second signal.

20. A second communication device, comprising a processor and a memory, wherein the memory stores a program or an instruction that is executable on the processor, and the program or the instruction is executed by the processor to implement the signal transmission method according to claim 10.
